(19) United States
(12) Patent Application Publication
(10) Pub. No.: US 2006/0221970 A1
(43) Pub. Date: Oct. 5, 2006

(54) Method of using a packet-switched network, a data processing system, a microphone system, and a speaker system

(75) Inventor: Edward Walter, Boerne, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P., Reno, NV (US)

(21) Appl. No.: 11/097,996

(22) Filed: Apr. 1, 2005

(51) Int. Cl. H04L 12/56

(52) U.S. Cl. 370/392; 370/401

(57) ABSTRACT

A method of using a packet-switched network can be used to deliver broadcast messages using a VoIP connection. Packets within the broadcast message can be intelligently routed to intended recipients based on one or more addresses for a logical segment of an organization (e.g., employees of a department), a physical segment (e.g., a building, floor of a building, meeting room, etc.), individuals, or any combination thereof. The broadcast message may be heard by a significantly higher fraction of intended recipients compared to all recipients because the routing of packets of the packet-switched network can reduce the number of unintended recipients as would occur when using a conventional analog public address system. Also, existing infrastructure can be used and does not require speaker wires to pass through walls or ceilings.

### BACKGROUND

1. Field of the Disclosure

The present disclosure relates to methods of using a packet-switched network, and more particularly to methods of using a packet-switched network for sending, transmitting, and receiving messages into data processing systems, microphone systems, and speaker systems.

2. Description of the Related Art

Voice broadcasts can be provided over an analog public address system. The voice messages can be broadcast over speakers or phones of a public branch exchange (“PBX”). The analog public address systems can allow for a method to send a broadcast message within a building. However, analog public address systems are typically part of a wireline system and can require significant power requirements locally at a microphone system, a speaker system, or both. Wireless and portable communication devices may not have sufficient local power to readily allow for an analog public address system.

### BRIEF DESCRIPTION OF THE DRAWINGS

FIG. 1 includes a block diagram of a Voice over Internet Protocol (“VoIP”) broadcast system in accordance with a particular embodiment.

FIG. 2 includes a block diagram of a VoIP microphone system in accordance with the embodiment illustrated in FIG. 1.

FIG. 3 includes a data processing system in accordance with the embodiment illustrated in FIG. 1.

FIG. 4 includes a block diagram of a VoIP speaker system in accordance with the embodiment illustrated in FIG. 1.

FIG. 5 includes a flow diagram of a method of broadcasting messages using a VoIP connection and the system of FIG. 1.

Skilled artisans will appreciate that elements in the figures are illustrated for simplicity and clarity and have not necessarily been drawn to scale.

### DETAILED DESCRIPTION

A method of using a packet-switched network can be used to deliver broadcast messages using a VoIP connection. Packets within the broadcast message can be intelligently routed to one or more intended recipients based on one or more addresses for a logical segment of an organization (e.g., employees of a department), a physical segment (e.g., a building, floor of a building, meeting room, etc.), individuals, or any combination thereof. The broadcast message may be heard by a significantly higher portion of intended recipients than analog public address systems since the routing of packets based on addresses using the packet-switched network can reduce the number of unintended recipients. Also, existing infrastructure can be used and does not require speaker wires to pass through walls or ceilings.

In a first aspect, a method can use at least one packet-switched network. The method includes receiving a broadcast message at a data processing system via a first packet-switched network, wherein the broadcast message is delivered via a VoIP connection and after an address within the broadcast message has been determined by a user that provided an audio content of the broadcast message. The method also includes transmitting the broadcast message from the data processing system via a second packet-switched network.

In a particular embodiment, the broadcast message includes a uni-directional communication that is not part of a conversation or a dialog, wherein the uni-directional communication can be heard by one or more intended recipients. In a particular embodiment, the broadcast message includes an address of a speaker that is part of a public address system.

In another embodiment, the method further includes transmitting the broadcast message from a microphone system to the data processing system via the first packet-switched network. In a particular embodiment, the method further includes receiving the broadcast message from the data processing system at a speaker system via the second packet-switched network. In a more particular embodiment, the broadcast message is communicated to a plurality of speakers via the second packet-switched network.

In a second aspect, a data processing system can be used with at least one packet-switched network. The data processing system can include a receiving module configured to receive a broadcast message via a first packet-switched network, wherein the broadcast message is delivered via a VoIP connection after an address within the broadcast message has been determined by a user that provided an audio content of the broadcast message, and a transmitting module is configured to transmit the broadcast message via a second packet-switched network.

In a third aspect, a VoIP microphone system can be used with a packet-switched network. The VoIP microphone system can included a microphone and a content module configured to receive content from the microphone, wherein the content is associated with a broadcast message, and an address module is configured to identify an address of an intended recipient for the broadcast message. The VoIP microphone system can also include a broadcast message module configured to receive the content from the content module and to associate the address from the address module with the content from the content module to form the broadcast message. The VoIP microphone system can further include a transmission module configured to send the broadcast message over the packet-switched network, wherein the broadcast message is communicated as a VoIP communication.

In another embodiment, the VoIP microphone system further includes an interface to a personal computer, a home entertainment system, a VoIP phone, or a combination thereof. In still another embodiment, the packet-switched network includes a wireless network.

In a fourth aspect, a VoIP speaker system can be used with a packet-switched network. The VoIP speaker system can include a receiver module configured to receive a broadcast message that is communicated as a VoIP communication, wherein the broadcast message is deliverable via the VoIP connection after an address within the broadcast message has been determined by a user that provided an audio content of the broadcast message, a content extraction module configured to extract content for the broadcast message, and an audio module configured to convert the extracted content to an audio signal.

The audio signal may be transmitted to speakers located in more than one room. In another embodiment, the receiver module, the content module, and the audio module can be incorporated into a personal computer, a home entertainment system, a wireline VoIP phone, or a mobile VoIP phone.

Before addressing details of particular illustrative embodiments described below, some terms are defined or clarified. The term “broadcast message” is intended to mean a uni-directional communication that is not part of a conversation or a dialog, wherein the uni-directional communication can be heard by one or more intended recipients of the uni-directional communication. For the purposes of this specification, messages that are transmitted or received by walkie-talkies are not broadcast messages because such messages transmitted or received by walkie-talkies are typically part of a conversation or dialog.

A VoIP system is a system that supports a communication transmitted from the VoIP system (e.g., VoIP microphone system) or received by the VoIP system (e.g., VoIP speaker system) using a connection between the VoIP system and a device or another system using an audio signal associated with a voice communication that is encoded using the Internet Protocol.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, for clarity purposes and to give a general sense of the scope of the embodiments described herein, the use of “a” or “an” are employed to describe one or more articles to which “a” or “an” refers. Therefore, the description should be read to include one or at least one whenever “a” or “an” is used, and the singular also includes the plural unless it is clear that the contrary is meant otherwise.

Unless stated otherwise, any combination of parts of a system may be bi-directionally or uni-directionally coupled to each other, even though a figure may illustrate only a single-headed arrow or a double-headed arrow. Arrows within the drawing are illustrated, as a matter of convenience, to show a principal information, data, or signal flow within the system or between the system and one or more components outside the system, one or more modules outside the system, another system, or any combination thereof in accordance with an embodiment. Coupling should be construed to include a direct electrical connection in one embodiment and alternatively, may include any one or more of an intervening switch, resistor, capacitor, inductor, router, firewall, network fabric or the like between any combination of one or more components, one or more devices, or one or more modules.

Unless otherwise defined, technical and scientific terms used herein have the same meaning as commonly understood by one of ordinary skill in the art to which this disclosure belongs. In addition, the materials, methods, and examples are illustrative only and not intended to be limiting.

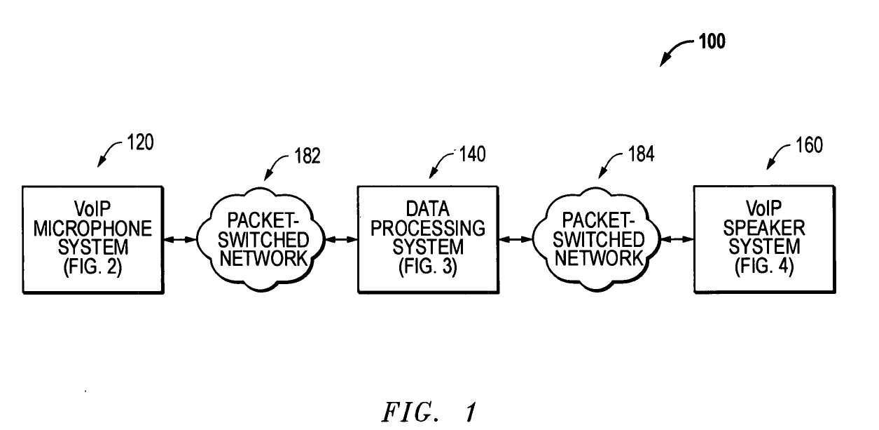

Attention is now directed to an exemplary system that can be used in a particular illustrative embodiment. FIG. 1 includes a block diagram of a public address system 100. The public address system 100 includes a VoIP microphone system 120 that is bi-directionally coupled to a first packet-switched network 182, and the first packet-switched network 182 is bi-directionally coupled to a data processing system 140. The data processing system 140 is bi-directionally coupled to a second packet-switched network 184, and the second package-switched network 184 is bi-directionally connected to a VoIP speaker system 160. The first and second packet-switched networks 182 and 184 may be the same or different from one another, and in a particular embodiment can include an internal network of a company, an external network, such as the Internet, or a combination thereof. Each of the packet-switched networks 182 and 184 can include one or more wireline connections, wireless connections, or a combination of wireline and wireless connections.

Each of the VoIP microphone system 120, the data processing system 140, and the VoIP speaker system 160 may reside in one or more separate devices. For example, each of the VoIP microphone system 120, the data processing system 140, and the VoIP speaker system 160 may each reside in separate devices. In another embodiment, the combination of the VoIP microphone system 120 and the data processing system 140 may reside within one device, or a combination of the data processing system 140 and the VoIP speaker system 160 may reside in one device. Exemplary devices can include a personal computer, a home entertainment system, a phone, and the like. In another embodiment, the data processing system 140 can be a set-top box, as used in an entertainment system, such as a home entertainment system. After reading this specification, skilled artisans will appreciate that a vast array of different devices can be used in implementing the public address system 100, as illustrated in FIG. 1.

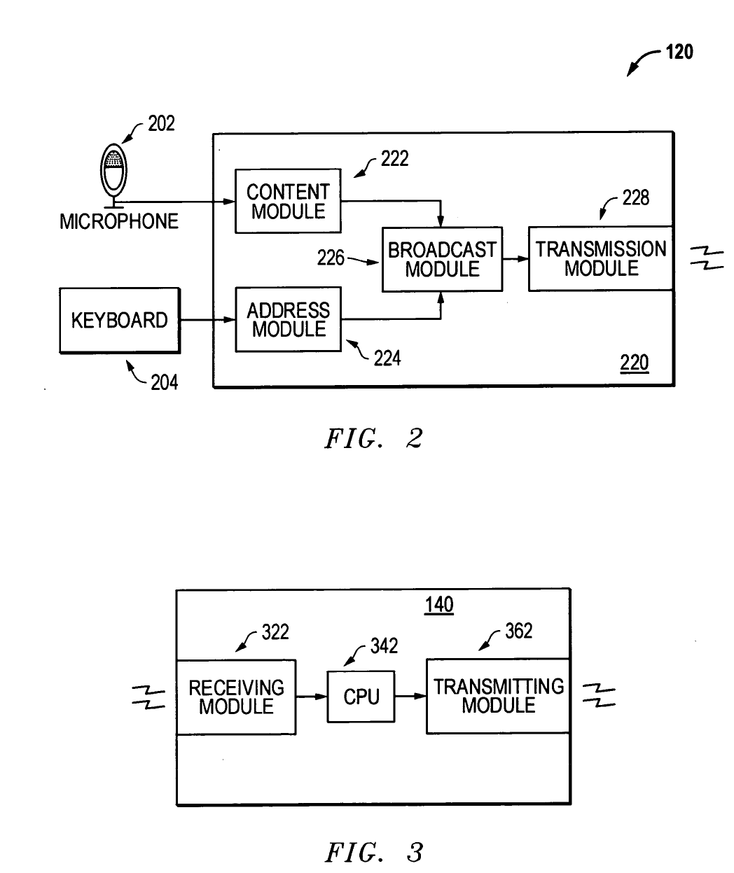

FIG. 2 includes a block diagram of an exemplary embodiment of the VoIP microphone system 120. The VoIP system 120 includes one or more input devices, such as a microphone 202, a keyboard 204, other input devices (e.g., mouse), or any combination thereof, commonly used with phones, personal computers, or entertainment centers. In one embodiment, each of the microphone 202 and the keyboard 204 is coupled to a microphone system base station 220. In other embodiments (not illustrated), the microphone 202, the keyboard 204, or other input devices may be included with the microphone system base station 220.

In one embodiment, the microphone 202 is coupled to a content module 222 that is configured to receive an audio signal from the microphone 202. A user can provide audio content by speaking into the microphone 202. The content module 222 is coupled to a broadcast module 226 that is configured to receive content from the content module 222. The keyboard 204 is coupled to an address module 224 that is configured to receive one or more addresses of a message to be delivered. The user who provides the audio contact can determine one or more addresses of one or more intended recipients. The address(es) may be typed by the user via the keyboard 204. In another embodiment, address(es) may be selected from a list, “click-and-dragged” into a window or other location in a display, or the like. Another input device (e.g., mouse, trackball, or other electronic pointer) can be used in place of or in conjunction with the address. The address(es) may be input by the user before or after the audio content is received by the content module 222.

The address(es) can include an address of nearly any logical or physical segment of an organization, an address of an individual, or any combination therefore. For example, an address for a logical segment may correspond to a department of the organization. The department may be located at different locations within different buildings, however, not all employees of the organization within those buildings belong to that department.

In another example, a physical segment may be a building or a floor of a building. Other logical or physical segments can be used. By using the address(es) of a logical or physical segment, a broadcast message may be more precisely sent to intended recipients. Therefore, the portion of intended recipients (i.e., those people that are intended to receive the broadcast message and potentially act on it) compared to all recipients receiving the broadcast message (including those people that are not affected by the broadcast message) is significantly higher than broadcasting a message over an analog public address system because with the disclosed system, the broadcast message can be intelligently routed to intended recipients using the packet-switched networks 182 and 184. The address module 224 is coupled to the broadcast module 226 that is configured to receive one or more addresses of intended recipients of the broadcast message.

The broadcast module 226 combines the content from the content module 222, the address(es) from the address module 224, and potentially other information to form a broadcast message. The broadcast module 226 is coupled to and forwards the broadcast message to a transmission module 228. The transmission module 228 can be a transmitter or a transceiver. The transmission module 228 may be configured to transmit a broadcast message to the data processing system 140 via the first packet-switched network 182.

FIG. 3 includes a block diagram of an exemplary embodiment of the data processing system 140. The data processing system 140 includes a receiving module 322 configured to receive a broadcast message transmitted from the VoIP microphone system 120. The receiving module 322 is coupled to a central processing unit (“CPU”) 342. The CPU 342 includes hardware, firmware, software, or any combination thereof that includes appropriate logic configured to extract addresses and potentially other information from the broadcast message as received by the receiving module 322. The CPU 342 can further include appropriate logic to extract the address(es) and route the broadcast message to such address(es) as indicated by the broadcast message. The CPU 342 is coupled to a transmitting module 362 that is configured to transmit the broadcast message to the VoIP speaker system 160 via the second packet-switched network 184.

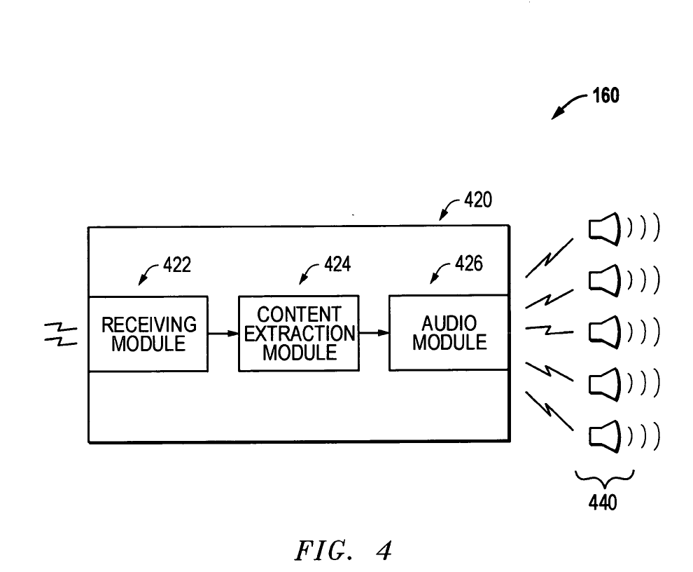

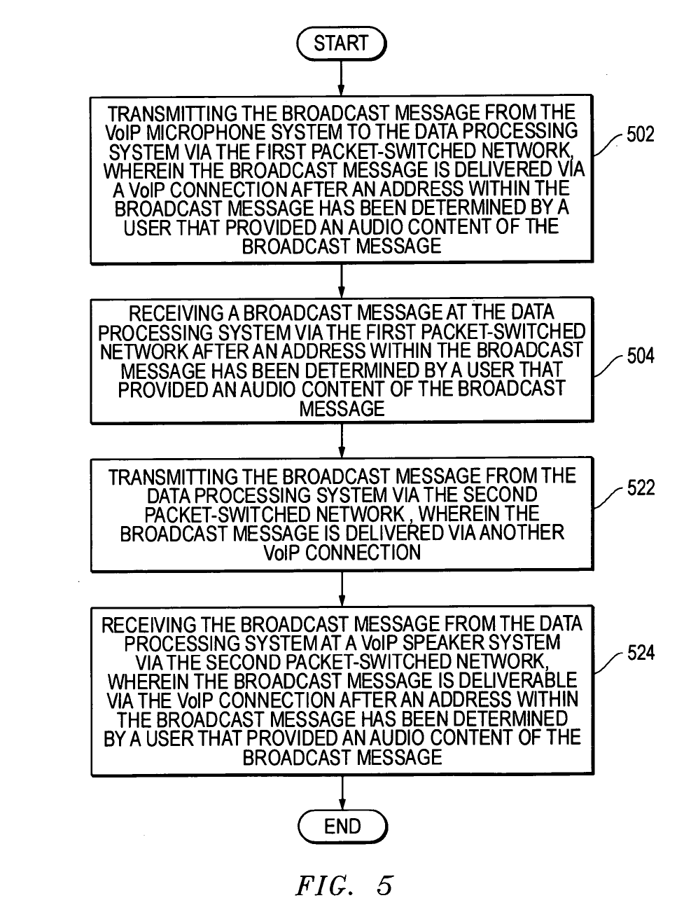

FIG. 4 includes a block diagram of the VoIP speaker system 160. The VoIP speaker system 160 includes a speaker system base station 420 that includes a receiving module 422 that is configured to receive the broadcast message from the data processing system 140 via the second packet-switched network 184. The receiving module 422 is coupled to a content extraction module 424 that is configured to extract content from the broadcast message. The content extraction module 424 is coupled to an audio module 426 that is configured to receive the content from the content extraction module 424. The audio module 426 is configured to convert the content from the content extraction module 424 into an audio signal that can be transmitted to one or more speakers 440. The connection between the audio module 426 and the speaker(s) 440 can include a wireless connection, a wireline connection, or a combination thereof. The speaker(s) 440 are configured to receive the audio signal from the audio module 426 and to produce an audible signal that can be heard by humans.

In one embodiment, a single speaker 440 may be used at a particular location to broadcast an audio signal derived from the content of the broadcast message to one or more intended recipients. In another embodiment, a plurality of speakers 440 can be used and may be located within a single room, such as an office, within a plurality of rooms within a single building, within different buildings, outside one or more buildings, or any combination thereof. The speakers in 440 may be incorporated within one or more telephones, one or more personal computers, one or more other audible communication devices, or any combination thereof.

FIG. 5 includes a flow diagram of an exemplary method of using the public address system 100. The method can include transmitting a broadcast message from a VoIP microphone system to a data processing system via a first packet-switched network, wherein the broadcast message can be delivered via a VoIP connection, as shown at 502. The method can also include receiving a broadcast message at the data processing system from the first packet-switched network after an address within the broadcast message has been determined by a user that provided an audio content of the broadcast message, at 504. The method can still further include transmitting the broadcast message from the data processing system via the second packet-switched network, wherein the broadcast message is delivered via another VoIP connection, at 522. The method can still further include receiving the broadcast message from the data processing system at the VoIP speaker system via the second packet-switched network, wherein the broadcast message is deliverable via the VoIP connection after an address within the broadcast message has been determined by a user that provided an audio content of the broadcast message, at 524. The speaker system can be used as a public or semipublic audio broadcast system to play an audio message using one or more speakers to intended recipients based on content extracted from the broadcast message.

One or more embodiments described herein allow broadcast messages to be more intelligently routed to intended recipients because the VoIP system allows packets of the broadcast message to be routed in accordance with the address(es) provided within the broadcast message. In addition, a broadcast VoIP system can be implemented without having to route wiring through walls or ceilings. In one implementation, a VoIP public address system may include the microphone system 120, a speaker system 160, or both using wireless connections. The data processing system 140 can also be accessed using wireless connections. Existing computer systems and networks can be used to implement the VoIP public address system. Designers have flexibility in designing VoIP public address systems that best meet their needs or desires.

After reading this specification, skilled artisans will appreciate that many other embodiments are possible. Therefore the embodiments described should be viewed as illustrative and not limiting to the scope of the present invention.

Note that not all of the activities described above in the general description or the examples are required, that a portion of a specific activity may not be required, and that one or more further activities may be performed in addition to those described. Still further, the order in which activities are listed are not necessarily the order in which they are performed. After reading this specification, skilled artisans will be capable of determining what activities can be used for their specific needs or desires.

Any one or more benefits, one or more other advantages, one or more solutions to one or more problems, or any combination thereof have been described above with regard to one or more particular embodiments. However, the benefit(s), advantage(s), solution(s) to problem(s), or any element(s) that may cause any benefit, advantage, or solution to occur or become more pronounced is not to be construed as a critical, required, or essential feature or element of any or all the claims.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of using at least one packet-switched network, the method comprising:
receiving a broadcast message at a data processing system via a first packet-switched network, wherein the broadcast message is delivered via a VoIP connection and after an address within the broadcast message has been determined by a user that provided an audio content of the broadcast message; and
transmitting the broadcast message from the data processing system via a second packet-switched network.

2. The method of claim 1, wherein the broadcast message comprises a uni-directional communication that is not part of a conversation or a dialog, wherein the uni-directional communication can be heard by one or more intended recipients.

3. The method of claim 2, wherein the broadcast message includes one or more addresses of the one or more intended recipients and wherein the one or more intended recipients are located proximate to a speaker that is part of a public address system.

4. The method of claim 1, further comprising transmitting the broadcast message from a microphone system to the data processing system via the first packet-switched network.

5. The method of claim 4, further comprising receiving the broadcast message from the data processing system at a speaker system via the second packet-switched network.

6. The method of claim 5, wherein the broadcast message is communicated to a plurality of speakers via the second packet-switched network.

7. The method of claim 1, wherein the first packet-switched network, the second packet-switched network, or a combination thereof, includes a wireless network.

8. A data processing system for use with at least one packet-switched network, the data processing system comprising:
a receiving module configured to receive a broadcast message via a first packet-switched network, wherein the broadcast message is deliverable via a VoIP connection after an address within the broadcast message has been determined by a user that provided an audio content of the broadcast message; and
a transmitting module configured to transmit the broadcast message via a second packet-switched network.

9. The data processing system of claim 8, wherein the broadcast message comprises a uni-directional communication that is not part of a conversation or a dialog, wherein the uni-directional communication can be heard by one or more intended recipients.

10. The data processing system of claim 9, wherein the broadcast message comprises an address of a speaker system that is part of a public address system.

11. The data processing system of claim 10, wherein the speaker system comprises a plurality of speakers that are connected to a wireless network.

12. The data processing system of claim 8, wherein the receiving module is further configured to receive the broadcast message from a microphone system.

13. The data processing system of claim 12, wherein the transmitting module is further configured to transmit the broadcast message to a plurality of speakers.

14. A Voice over Internet Protocol (VoIP) microphone system for use with a packet-switched network, the VoIP microphone system comprising:
a microphone;
a content module configured to receive audio content from the microphone;
an address module configured to identify an address of an intended recipient for a broadcast message including the audio content;
a broadcast message module configured to receive the audio content from the content module and to associate the address from the address module with the audio content from the content module to form the broadcast message; and
a transmission module configured to send the former broadcast message over the packet-switched network, wherein the broadcast message is communicated as a Voice over Internet Protocol (VoIP) communication.

15. The VoIP microphone system of claim 14, wherein the address comprises an address of a location of a VoIP speaker that is part of a public address system.

16. The VoIP microphone system of claim 14, further comprising an interface to a personal computer, a home entertainment system, a VoIP phone, or a combination thereof.

17. The VoIP microphone system of claim 14, wherein the packet-switched network includes a wireless network.

18. A Voice over Internet Protocol (VoIP) speaker system for use with a packet-switched network, the VoIP speaker system comprising:
a receiver module configured to receive a broadcast message that is communicated as a VoIP communication over the packet-switched network, wherein the broadcast message is deliverable via the VoIP connection after an address within the broadcast message has been determined by a user that provided an audio content of the broadcast message;
a content extraction module configured to extract audio content from the broadcast message; and
an audio module configured to convert the extracted audio content to an audio signal.

19. The VoIP speaker system of claim 18, wherein the audio signal is transmitted to speakers located in more than one room.

20. The VoIP speaker system of claim 18, wherein the receiver module, the content module, and the audio module are incorporated into a personal computer, a home entertainment system, a wireline VoIP phone, or a mobile VoIP phone.

21. The VoIP speaker system of claim 18, further comprising a plurality of speakers coupled to receive the audio signal.

22. The VoIP speaker system of claim 18, wherein the packet-switched network includes a wireless network.
